(19) United States
(12) Patent Application Publication
(10) Pub. No.: US 2026/0317562 A1
(43) Pub. Date: Oct. 15, 2026

(54) AMINE POLYMERS MODIFIED WITH POLY(CATECHOL-STYRENE) COPOLYMERS

(71) Applicant: Mussel Polymers, Inc., Bethlehem, PA (US)

(72) Inventors: Jim A. Bailey, III, Allentown, PA (US); Richard C. MacQueen, Phillipsburg, NJ (US); Jason Stieg, Lafayette Hill, PA (US)

(21) Appl. No.: 19/643,492

(22) Filed: Apr. 9, 2026

Related U.S. Application Data
(60) Provisional application No. 63/785,875, filed on Apr. 9, 2025.

(51) Int. Cl. C09D 7/65; C08G 59/24; C08G 59/50; C08K 3/014; C08K 3/04; C08K 3/22; C08L 25/04; C09D 5/02; C09D 5/08; C09D 7/80; C09D 163/00; C09D 175/02; C09J 163/00

(52) U.S. Cl. CPC C09D 7/65; C08G 59/245; C08G 59/5006; C08G 59/5026; C08G 59/5033; C08K 3/014; C08K 3/04; C08L 25/04; C09D 5/028; C09D 5/086; C09D 7/80; C09D 163/00; C09D 175/02; C09J 163/00; C08K 2003/2241

(57) ABSTRACT

The present disclosure provides a two-part catechol-containing polymer composition comprising a PCS-containing amine part and a hardening agent part.

### CROSS-REFERENCE TO RELATED APPLICATION

This application claims the benefit of U.S. Provisional Application No. 63/785,875, filed Apr. 9, 2025, the entirety of which is incorporated by reference herein.

### TECHNICAL FIELD

The present invention is related to catechol-containing compounds and their use as adhesives.

### BACKGROUND

Polyurea is an elastomer derived from the reaction product of an isocyanate component and an amine component. The isocyanate component can be aromatic or aliphatic in nature. It can include a monomer, a polymer, or any variant reaction of isocyanates, quasi-prepolymer or a prepolymer. The prepolymer, or quasi-prepolymer, can be made of an amine-terminated polymer resin, or a hydroxyl-terminated polymer resin. (https://en.wikipedia.org/wiki/Polyurea). The resin blend may be made up of amine-terminated polymer resins, and/or amine-terminated chain extenders. The amine-terminated polymer resins do not have any intentional hydroxyl moieties. Any hydroxyls are the result of incomplete conversion to the amine-terminated polymer resins. The resin blend may also contain additives or non-primary components.

Polyurea polymers made with secondary amines called aspartics, also called polyaspartics, were discovered in the 1990's. They have found great utility as coatings, adhesives and caulks for metals, concrete, plastics, and wood substrates. They react rapidly with isocyanates without the need for a catalyst compared with polyurethane coatings.

These additives may contain hydroxyls, such as pre-dispersed pigments in a polyol carrier. Polyurea and epoxy polymers, while having many terrestrial applications such as coatings, adhesives, and caulks, have not had utility in high moisture conditions and/or as underwater applied coatings, adhesives, or caulks.

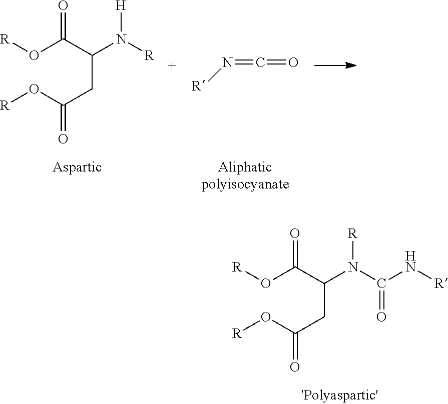

However, as they are secondary amines rather than primary, their reaction time is slow enough to allow sufficient time for mixing and application compared to conventional polyureas.

### Epoxy Polymers

Epoxy polymers are made by reacting multifunctional glycidyl ether groups (called epoxy) and polyfunctional amines. The three reactions creating the epoxy polymer are shown below. Two-part epoxies are widely known and used in a variety of applications including coatings, adhesives, encapsulates, etc.

### 1. Primary Amine-Epoxy Addition

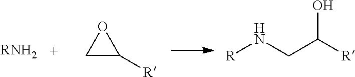

### 2. Secondary Amine-Epoxy Addition

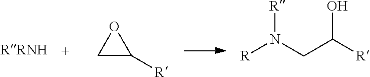

### 3. Hydroxyl-Epoxy Addition (Esterification)

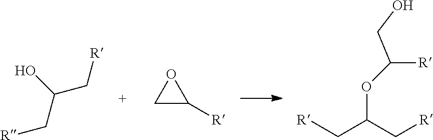

Accordingly, there is a need in the art to extend the application of epoxy to very wet and/or water-submerged substrates. The present disclosure addresses this need.

### SUMMARY

The disclosure provides two-part curable compositions comprising:
a. a first part comprising:
   a nucleophilic amine-containing compound; and
   a poly(catechol-styrene) (PCS) polymer;
   and
b. a second part comprising:
   an electrophilic compound that is capable of reacting with the nucleophilic amine-containing compound of the first part.

Methods of using the two-part curable composition are also disclosed.

### BRIEF DESCRIPTION OF THE DRAWINGS

FIG. 1 shows an image of two steel panels that were submerged in water. The panel on the left is a control panel that was coated with a two-part composition that includes a secondary amine and isocyanate. The panel on the right was coated with a two-part composition that includes a PCS-containing secondary amine and isocyanate. In the control panel, the coating did not grab or coat the steel at all and just formed spherical globs that dispersed and floated away.

FIGS. 2A, 2B, and 2C show the formulations described in Table 2 that were mixed and applied with a foam brush to DH36 steel submerged in tap water. In each picture from left to right, it shows formula 1, 2, and 3 as described in Table 2 below. The top panels is a control panel without PCS and the bottom panel shows a formulation that includes with PCS. Clearly the PCS allows the epoxy to grab, bond and wet out the steel underwater, whereas without very little bonding and wet out. FIG. 2A shows the panels initially after application. FIG. 2B shows the panels 72 hours after application. FIG. 2C shows the panels after being removed from the water and rinsed off following 72 hours of submersion in tap water.

FIG. 3 shows the lap shear data from the Experiment described in Example 3.

FIG. 4 shows the data from Example 4.

FIG. 5 shows the data from Example 4.

FIG. 6 shows a table listing some commercially available polyisocyanates and epoxies.

FIG. 7 shows a table listing some commercially available polyamines/amides.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents, and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated+10% variation unless otherwise indicated or implied. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Unless otherwise indicated, references herein to molecular weights are weight average molecular weights.

Any documents cited herein are incorporated by reference in their entireties for any and all purposes.

Polyurea and epoxy polymers, while having many terrestrial applications such as coatings, adhesives, and caulks, have not had utility in high moisture conditions and/or as underwater applied coatings, adhesives, or caulks. Surprisingly, it has been discovered that by dissolving a small percentage of poly(catechol-styrene) (PCS) into an aspartic resin (secondary amine) and/or an amine such as a polyamine, the underwater grab, wetting and adhesion to metals of a two-part polyurea coating (e.g., isocyanate and aspartic) and a two-part epoxy (e.g., epoxy resin and poly-functional amine) are greatly increased.

PCS is a high glass transition temperature thermo-plastic solid copolymer (100-140° C.). Therefore, it must be dissolved in medium polarity solvents such as ketones, acetates, and some glycols to be formulated into a liquid coating, adhesive or caulk formulation. Thus, the composition of the present disclosure allows PCS to be dissolved in an aspartic resin or an amine that acts as a reactive diluent in that it provides a carrier for the PCS and also reacts with the hardening agent, e.g., isocyanate or epoxy, to form a very high solids system (>85% solids). Advantageously, the formulation of these compositions eliminates the need for solvents altogether.

In some aspects, the disclosure provides two-part curable compositions comprising:
a. a first part comprising:
   a nucleophilic amine-containing compound; and
   a poly(catechol-styrene) (PCS) polymer;
   and
b. a second part comprising:
   an electrophilic compound that is capable of reacting with the nucleophilic amine-containing compound of the first part.

### First Part

In some aspects, the first part of the two-part curable compositions comprise a nucleophilic amine-containing compound.

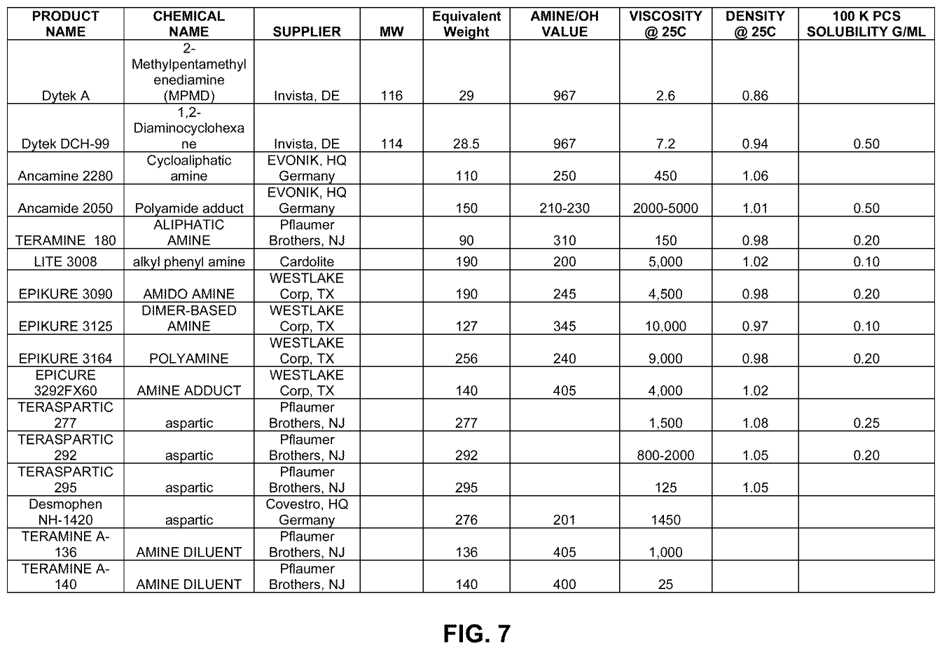

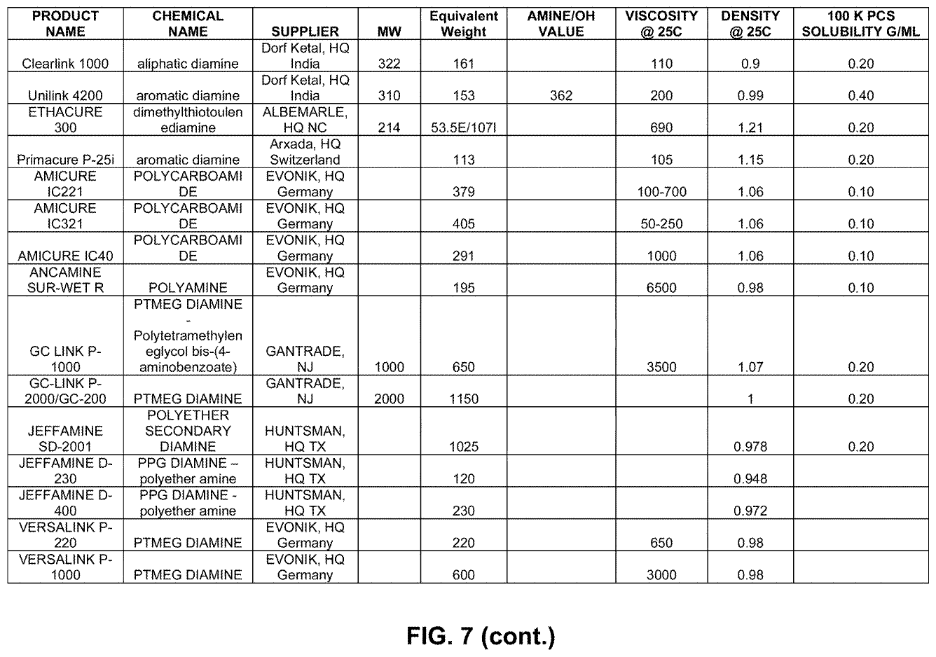

In some embodiments, the nucleophilic amine-containing compound of the first part is one or more of the compounds listed in FIG. 7.

In some embodiments, the nucleophilic amine-containing compound is a secondary amine. In some embodiments, the secondary amine is an aspartic or an aspartic resin, such as, for example, those sold under the tradename TERASPARTIC®.

In other embodiments, the nucleophilic amine-containing compound is a polyamine, such as, for example, an aliphatic diamine or a cycloaliphatic diamine.

In some embodiments, the polyamine is 2-methylpentamethylenediamine, or 1,2-diaminocyclohexane.

In other embodiments, the polyamine is 4,4′-methylenebiscyclohexanamine, such as that sold under the tradename ANCAMINE® 2280.

In some aspects, the first part of the two-part curable compositions comprise a poly(catechol-styrene) (PCS) polymer. In some embodiments of the first part, the PCS is in admixture with the nucleophilic amine-containing compound. In some embodiments of the first part, the PCS is dissolved in the nucleophilic amine-containing compound. PCS is a copolymer comprising catechol and styrene monomeric units. PCS and methods of making PCS are known in the art, and include those set forth in WO2024158899A1, which is incorporated by reference herein in its entirety.

In some aspects, the PCS used in the two-part curable compositions of the disclosure has a molecular weight ranging from 15,000 Da to 1,000,000 Da, such as 15,000 Da to 188,000 Da as measured by gel permeation chromatography (GPC). In some embodiments, the PCS has a molecular weight of about 50,000 Da to about 400,000 Da, such as, for example, about 50,000 Da, 75,000 Da, 100,000 Da, 125,000 Da, 150,000 Da, 175,000 Da, 200,000 Da, 225,000 Da, 250,000 Da, 275,000 Da, 300,000 Da, 325,000 Da, 350,000 Da, 375,000 Da, or 400,000 Da, as measured by GPC. In other embodiments, the PCS has a molecular weight of about 80,000 Da to about 130,000 Da, such as, for example, about 80,000 Da, about 85,000 Da, about 90,000 Da, about 95,000 Da, about 100,000 Da, about 105,000 Da, about 110,000 Da, about 115,000 Da, about 120,000 Da, about 125,000 Da, about 130,000 Da, as measured by GPC.

In some embodiments, the PCS used in the two-part curable compositions of the disclosure has a molecular weight of about 100,000 Da.

In some embodiments, the poly(catechol-styrene) polymer used in the two-part curable compositions has a polydispersity index (PDI) of about 1 to about 4 as measured by GPC, such as, for example, about 1, about 1.1, about 1.2, about 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, or about 4.

In other embodiments, the poly(catechol-styrene) polymer used in the two-part curable compositions has a polydispersity index (PDI) of about 2 to about 4, as measured by GPC, such as, for example, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, or about 4.

In yet other embodiments, the poly(catechol-styrene) polymer used in the two-part curable compositions has a polydispersity index (PDI) of about 2 to about 3, as measured by GPC, such as, for example, about 2, about 2.1, about 2.2, about 2.3, about 2.4, about 2.5, about 2.6, about 2.7, about 2.8, about 2.9, or about 3.

In some embodiments, the catechol content of the PCS used in the two-part curable compositions ranges from about 10% to about 75% by weight, such as, for example, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, or about 75% by weight.

In some embodiments, the catechol content of the PCS polymer used in the two-part curable compositions is about 75% by weight.

In some embodiments, the catechol content of the PCS used in the two-part PCS-containing polymer composition ranges from about 10% to about 75% by weight, such as, for example, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, or about 75% by weight.

In some embodiments, the PCS content of the two-part curable compositions ranges from about 1% to about 15% by weight, such as, for example, about 1%, about 2%, about 3%, about 4%, about 5%, about 6%, about 7%, about 8%, about 9%, about 10%, about 11%, about 12%, about 13%, about 14%, or about 15%, by weight.

In some embodiments, one or more additives are included in the first part of the two-part curable compositions. The one or more additives can include, for example, one or more catalysts, pigments, surfactants, corrosion inhibitors, fillers, combinations of the foregoing additives, and the like.

In some embodiments, the pigment comprises a titanium white pigment including, for example, TERACHEM® White or one or more other commercially available titanium white pigments. In some embodiments, the pigment comprises tinting black. The tinting black can include TERACHEM® Black or one or more other commercially available tinting black pigments. TERACHEM is a line of pigment dispersions with many colors available, available from Pflaumer Brothers.

In some aspects, the one or more additives includes a surfactant. In some embodiments, the surfactant can include a silicone-based surfactant such as, for example, BYK®-306, which is a polyether-modified polydimethylsiloxane available from BYK-Chemie GmbH.

In some aspects, the one or more additives includes a corrosion inhibitor. The corrosion inhibitor can include an organic corrosion inhibitor. In some embodiments, the organic corrosion inhibitor comprises HALOX® 680. HALOX® 680 is an organic heterocyclic ion exchange inhibitor available from ICL Phosphate Specialty.

### Second Part

In some aspects, the second part of the two-part curable compositions comprise an electrophilic compound that is capable of reacting with the nucleophilic amine-containing compound of the first part. Electrophilic moieties that are capable of reacting with nucleophilic amines, as well as resins containing those moieties are known in the art. See, e.g., https://chem.libretexts.org/Bookshelves/Organic_Chemistry/Map % 3A_Organic_Chemistry_(Wade)_Complete_and_Semesters_I_and_II/Map % 3A_Organic_Chemistry_(Wade)/20%3A_Amines/20.06% 3A_Reactions_of_Amines #:~:text=The % 20reaction%20of%20aldehydes.

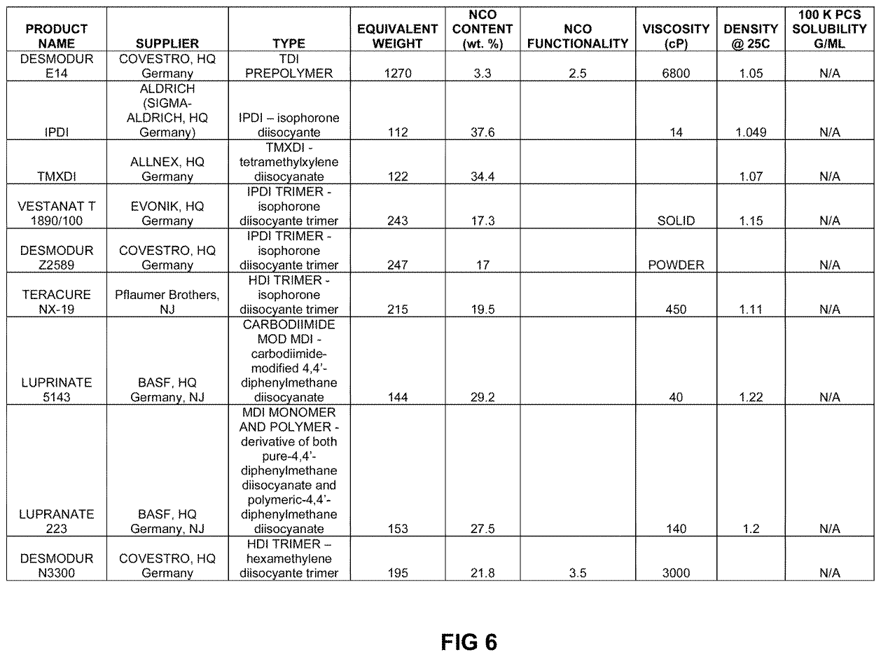

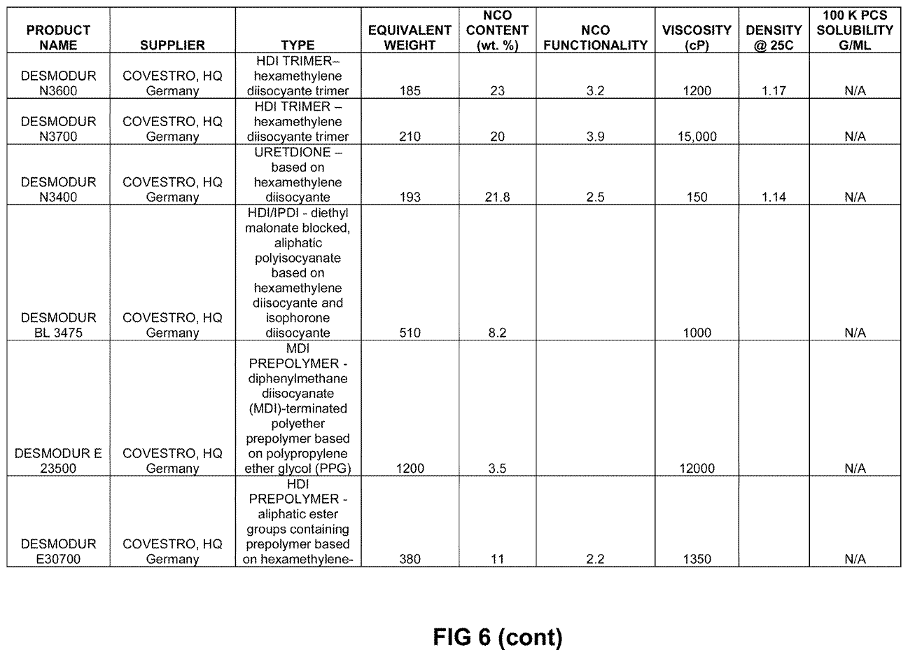

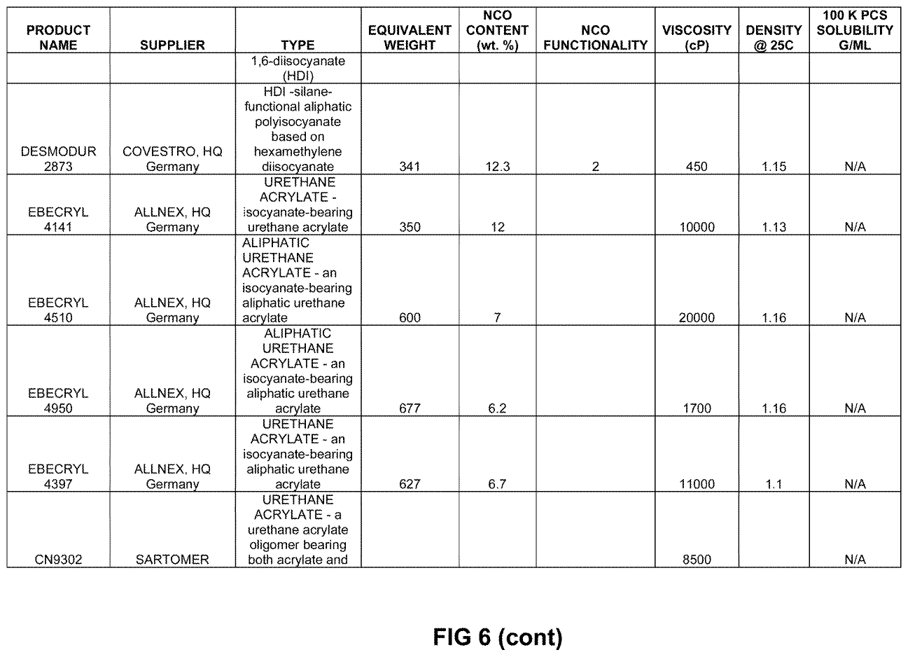

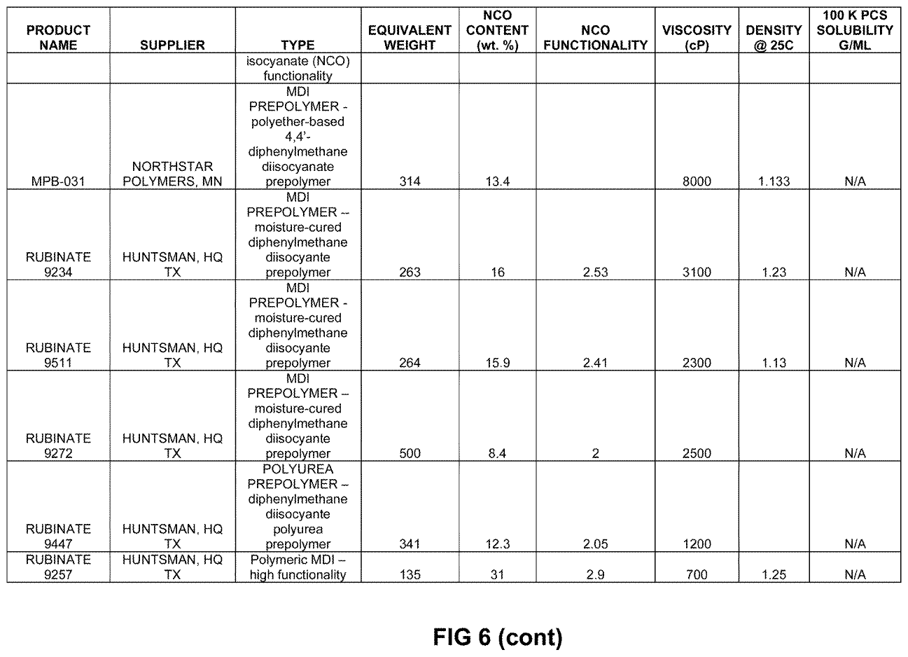

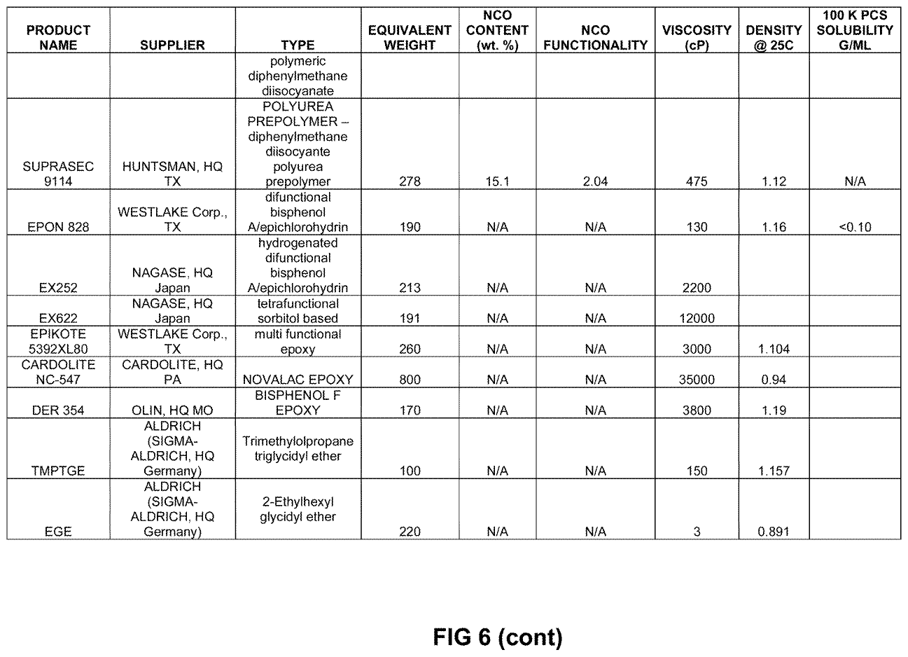

In some embodiments, the electrophilic compound that is capable of reacting with the nucleophilic amine-containing compound of the first part is one or more of the compounds listed in FIG. 6.

In some embodiments, the electrophilic compound that is capable of reacting with the nucleophilic amine-containing compound of the first part is an isocyanate. In some embodiments, the isocyanate is a low-viscosity aliphatic polyisocyanate. In some embodiments, the isocyanate comprises TERACURE® NX-19.

In some embodiments, the electrophilic compound that is capable of reacting with the nucleophilic amine-containing compound of the first part is an epoxy resin. In some embodiments, the epoxy is an unmodified resin such as diglycidyl ether of bisphenol A. For example, in some embodiments the epoxy can include EPON™ Resin 828.

More generally, it will be understood by those skilled in the art that the electrophilic compound that is capable of reacting with the nucleophilic amine-containing compound of the first part may, in some embodiments, be a prepolymer. For example, an excess of diisocyanate monomer may react with a polyol to form an isocyanate-terminated polyurethane prepolymer that has unreacted isocyanate moieties which are the electrophilic functionality that can react with amine in the 2-part compositions of the disclosure. As a second example, epoxide-forming reagents (such as epichlorohydrin reacting with bisphenol A) may be partially reacted to create an epoxy prepolymer that contains reactive epoxide groups which are the electrophilic functionality that can react with amine in the 2-part compositions of the disclosure.

In some aspects, the second part of the two-part curable compositions further comprise one or more additives. The one or more additives can include one or more pigments, one or more surfactants, one or more corrosion inhibitors, one or more fillers, or one or more combinations thereof.

In some embodiments, the pigment comprises a titanium white pigment including, for example, TERACHEM® White or one or more other commercially available titanium white pigments. In some embodiments, the pigment comprises tinting black. The tinting black can include TERACHEM® Black or one or more other commercially available tinting black pigments. TERACHEM is a line of pigment dispersions with many colors available.

In some aspects, the one or more additives includes a surfactant. In some embodiments, the surfactant can include a silicone-based surfactant such as, for example, BYK®-306.

In some aspects, the one or more additives includes a corrosion inhibitor. The corrosion inhibitor can include an organic corrosion inhibitor. In some embodiments, the organic corrosion inhibitor comprises HALOX® 680.

### Use of Two-Part Compositions

The two-part curable compositions of the disclosure are suitable for a variety of functional uses, including, but not limited to, use as a coating, an adhesive, or a sealant.

In some embodiments, the two-part curable compositions of the disclosure are coatings.

In other embodiments, the two-part curable compositions of the disclosure are sealants.

In other embodiments, the two-part curable compositions of the disclosure are adhesives.

In some embodiments, the two-part curable compositions of the disclosure are fillers.

The two-part curable compositions of the disclosure are used by mixing the first part with the second part and then applying the resulting mixture to the substrate to be coated.

In some aspects, the first part and the second part may be mixed in any weight ratio that provides a composition useful for a particular application.

In some embodiments, the two-part curable compositions are used by combining the second part and the first part in a weight ratio of about 0.1:1 to about 8:1 (second part:first part), such as, for example, about 0.1:1, about 0.2:1, about 0.3:1, about 0.4:1, about 0.5:1, about 0.6:1, about 0.7:1, about 0.8:1, about 0.9:1, about 1:1, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, about 1:5, about 1:5.1, about 1:5.2, about 1:5.3, about 1:5.4, about 1:5.5, about 1:5.6, about 1:5.7, about 1:5.8, about 1:5.9, about 1:6, about 1:6.1, about 1:6.2, about 1:6.3, about 1:6.4, about 1:6.5, about 1:6.6, about 1:6.7, about 1:6.8, about 1:6.9, about 1:7, about 1:7.1, about 1:7.2, about 1:7.3, about 1:7.4, about 1:7.5, about 1:7.6, about 1:7.7, about 1:7.8, about 1:7.9, or about 1.8 (second part:first part).

In some embodiments, the two-part curable compositions are used by combining the second part and the first part in a weight ratio of about 1:1 to about 8:1, such as, for example, about 1:1, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, about 1:5, about 1:5.1, about 1:5.2, about 1:5.3, about 1:5.4, about 1:5.5, about 1:5.6, about 1:5.7, about 1:5.8, about 1:5.9, about 1:6, about 1:6.1, about 1:6.2, about 1:6.3, about 1:6.4, about 1:6.5, about 1:6.6, about 1:6.7, about 1:6.8, about 1:6.9, about 1:7, about 1:7.1, about 1:7.2, about 1:7.3, about 1:7.4, about 1:7.5, about 1:7.6, about 1:7.7, about 1:7.8, about 1:7.9, or about 1.8 (second part:first part).

In some embodiments, the two-part curable compositions are used by combining the second part and the first part in a weight ratio of about 1:2 by weight (second part:first part). In some embodiments, the weight ratio of second part to first part is about 1:1, about 1:1.2, about 1:1.4, about 1:1.6, about 1:1.8, about 1:2, about 1:2.2, about 1:2.4, about 1:2.6, about 1:2.8, about 1:3, or values therebetween.

In some embodiments, the two-part curable compositions comprises a first part comprising PCS and secondary amine and a second part comprising an isocyanate that are combined in a ratio of about 1:2 by weight of second part to first part. In some embodiments, the weight ratio of second part to first part is about 1:1, about 1:1.2, about 1:1.4, about 1:1.6, about 1:1.8, about 1:2, about 1:2.2, about 1:2.4, about 1:2.6, about 1:2.8, about 1:3, or values therebetween.

In some embodiments, the two-part curable compositions comprise a first part comprising PCS and polyamine and a second part comprising an epoxy that are combined in a ratio of about 1.2:1 by weight second part to first part.

In some embodiments, the two-part curable compositions comprise a first part comprising PCS and a polyamine and a second part comprising an epoxy that are combined at a ratio of about 7:1 by weight second part to first part. In some embodiments, the ratio of epoxy to polyamine is a ratio by weight of about 1:1, about 1.2:1, about 1.4:1, about 1.6:1, about 1.8:1, about 2:1, about 2.2:1, about 2.4:1, about 2.6:1, about 2.8:1, about 3:1, about 3.2:1, about 3.4:1, about 3.6:1, about 3.8:1, about 4:1, about 4.2:1, about 4.4:1, about 4.6:1, about 4.8:1, about 5:1, about 5.2:1, about 5.4:1, about 5.6:1, about 5.8:1, about 6:1, about 6.2:1, about 6.4:1, about 6.6:1, about 6.8:1, about 7:1, about 7.2:1, about 7.4:1, about 7.6:1, about 7.8:1, about 8:1, or one or more values therebetween.

In some embodiments, the two-part curable compositions comprises a first part comprising aspartic or aspartic resin and PCS, and a second part comprising an isocyanate.

In other embodiments, the two-part curable compositions comprises a first part comprising a polyamine and PCS, and a second part comprising an epoxy resin.

### EXAMPLES

The following Examples are provided to illustrate some of the concepts described within this disclosure. While the Examples are considered to provide embodiments, it should not be considered to limit the more general embodiments described herein.

### Example 1—PCS-Modified Aspartic Resin

The polyaspartic system of the invention is a two-part liquid coating/adhesive/caulk that is mixed just prior to application. The ingredients are divided between the two parts in general where the aspartic with pre-dissolved PCS, pigments, surfactants, corrosion inhibitors, fillers, etc. are in a first part and the isocyanate(s) alone are the second part. Depending on the viscosity of the parts, the second part is added to the first part in the appropriate ratio and hand mixed for small quantities or mechanically mixed for larger quantities (>1 gallon).

Small scale application (<5 square feet) can be accomplished with a roller, paint brush, and/or squeegee where the mixed polyaspartic is applied to the applicator above water and then applied to the substrate under water. For large scale application, a two-component pumping system, mixer, and roller/squeegee would be used where the mixing would ideally be done as close to the applicator as possible. Thus, the components would be pumped from the pier through separate hoses to the applicator and applied by divers.

It was discovered that dissolving a small percentage of PCS into an aspartic resin greatly increases the underwater tack, wetting, and adhesion of a two-part polyurea/polyaspartic coating formulated with an isocyanate and the PCS-modified aspartic resin.

0.05 to 0.25 g/ml PCS was dissolved into an aspartic resin at room or at elevated temperature (<60° C.). The resulting mixture has a higher viscosity and more “body” than the aspartic resin alone. The resulting PCS modified aspartic is then mixed with an isocyanate in a ratio (e.g., 1:2 isocyanate to aspartic by weight). The resulting mixture is brushed onto a piece of cold rolled steel immersed in artificial seawater to form a uniform smooth coating without de-wetting. Repeating the same procedure without the PCS results in the inability to form a coating as the polyurea does not adhere to the steel and disperses in the seawater.

Proof of concept testing in the lab was done by mixing up small amounts (50-100 ml) of coating and applying to DH36 steel that has been surface treated using the SP3 procedure (handheld mechanical sanding). The steel was submerged in 4-8″ of artificial seawater. The ease of application was evaluated by the coatings' ability to transfer from the applicator to the steel (“grabbing” the steel), wetting of the steel substrate, and how much material floats/sinks during application. The coated panel was allowed to cure in the room temperature seawater for 24 h and then removed, dried off, and evaluated.

This evaluation included: Visual evaluation of coating coverage, smoothness, and uniformity; Thickness measurements (Elcometer); and Hardness measurements (ASTM D3363); Adhesion (ASTM D4541). Additionally, characterization of the liquid components included evaluating density, viscosity, and working time after mixing. The formulation work has shown that several factors are important in developing an under-water applied and cured coating including: density (sink, float or hover); solubility in water (none); affinity for the substrate to be coated versus the application tool (does it stick, wet out on the substrate more than the tool?); harden/cure under water to give desired properties (solvent removal, chemical reaction).

Table 1 below shows a formula of the invention. The first part of the two-part composition is prepared by dissolving 0.2 g/ml of PCS in the aspartic 292. The other ingredients are then mixed in with a mechanical low shear stirring rod. The second part is then added to the first part and mixed. The working time at room temperature is about 10 minutes. The mixture is then applied to submerged steel as described in the previous section. After 24 h, the coated steel is removed from the water and a cured, uniform, glossy, gray coating is observed. The coating hardness is 3B and the adhesion is 420 psi. The density of the mixture before cure is 1.04 g/ml which is very close to that of seawater (1.03 g/ml) at room temperature.

TABLE 1
Two- Part Polyurea Formulation

| Ingredient | Supplier | Purpose | wt. % |
|---|---|---|---|
| First Part: | | | |
| TERASPARTIC 292 | Pflaumer | Aspartic | 48.42 |
| | Brothers, NJ | | |
| 100K PCS | MPI, Mussel | Adhesion promoter | 9.22 |
| | Polymers, Inc. | | |
| | aka the Applicant | | |
| TERACHEM WHITE | Pflaumer | Pigment dispersion | 6.05 |
| | Brothers, NJ | | |
| TERACHEM BLACK | Pflaumer | Pigment dispersion | 6.05 |
| | Brothers, NJ | | |
| Byk 306 | BYK-Chemie | Surfactant | 4.03 |
| | GmbH, Germany | | |
| Halox 680 | ICL/Halox, IN | Corrosion inhibitor | 2.02 |
| Second Part: | | | |
| TERACURE NX-19 | Pflaumer | Isocyanate | 24.21 |
| | Brothers, NJ | | |
| Total | | | 100.00 |

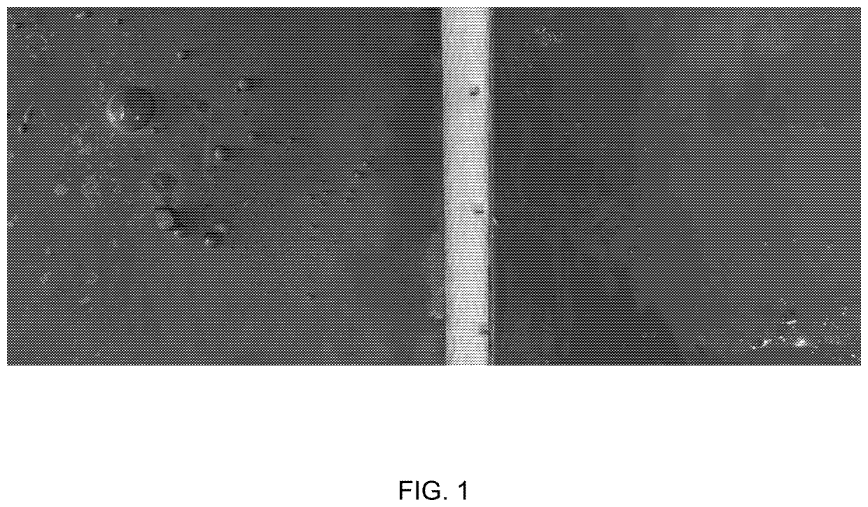

To determine the effect of adding the PCS to the aspartic, the same formula as shown in Table 1 was prepared, but the PCS was not added. The coating was applied to submerged steel as described previously. The coating did not grab or coat the steel at all and just formed spherical globs that dispersed and floated away. If the globs settled on the steel, they could be brushed away showing no adhesion at all. The image in FIG. 1 shows the invention on the right and the control without PCS on the left prepared as described previously.

Additionally, the viscosity and rheology of the aspartic changed drastically after the PCS was dissolved showing higher viscosity and more “body”.

### Example 2—PCS-Modified Epoxy Resin

The epoxy systems of this invention are two-part coatings/adhesive/etc. that are mixed prior to application. Epoxies typically have longer working times than aspartics (up to hours versus minutes). The ingredients are divided between a first part comprising the amine with pre-dissolved PCS and a second part comprising the epoxy(s) as well as catalysts, pigments, surfactants, corrosion inhibitors, fillers, etc. Depending on the viscosity the parts, the first part is added to the second part in the appropriate ratio and hand mixed for small quantities or mechanical mixed for larger quantities (>1 gallon).

Application is similar to the aspartic systems as described above.

For naval applications, the requirements for an underwater applied coatings are defined by NAVSEA Pub S-0600-AA-PRO-200. For other applications (coatings, adhesives, caulks), the requirements would be determined by military or industry standards and/or customer requirements.

It has been discovered that dissolving a small percentage of PCS into an amine (primary, secondary) greatly increases the underwater tack, wetting and adhesion of a two-part epoxy coating formulated with an epoxy resin and the PCS modified amine.

0.05 to 0.6 g/ml PCS is dissolved into a polyamine at room or elevated temperature (60 C). The resulting mixture has a higher viscosity and more “body” than the polyamine resin alone. The resulting PCS modified polyamine is then mixed with an epoxy resin a ratio (e.g., 7:1 epoxy:amine by weight). The resulting mixture is brushed onto a piece of cold rolled steel immersed in artificial seawater to form a uniform smooth coating without de-wetting. Repeating the same procedure without the PCS results in the inability to form a uniform coating as the epoxy does not adhere to the steel and disperses in the seawater.

Preliminary results using the epoxy coatings were shown in Table 2 below and are simple tertiary mixtures. Control samples did not have PCS dissolved in the amine. In Formulas 1 and 2, the weight ratio of epoxy to amine (w/or w/o PCS) was 7:1 where the PCS was dissolved in the amines at 0.5 g/ml in the amines. In formula 3 the epoxy to amine weight ratio (w/and w/o PCS) was 1.2:1 where PCS was dissolved at 0.2 g/ml in the amine.

TABLE 2
Epoxy Formulations

| Formula | Ingredient | Supplier | wt. % |
|---|---|---|---|
| 1 | EPON 828 | Westlake | 87.5 |
| | | Corp., TX | |
| | 2-Methylpentamethylenediamine (MPMD) | Invista, DE | 5.2 |
| | 100K MW PCS | MPI Mussel | 7.3 |
| | | Polymers, | |
| | | Inc. aka the | |
| | | Applicant | |
| 2 | EPON 828 | Westlake | 87.5 |
| | | Corp., TX | |
| | 1,2-Diaminocyclohexane | Invista, DE | 5.9 |
| | 100K MW PCS | MPI Mussel | 6.6 |
| | | Polymers, | |
| | | Inc. aka the | |
| | | Applicant | |
| 3 | EPON 828 | Westlake | 54.5 |
| | | Corp., TX | |
| | Unilink 4200 | Dorf Ketal, | 37 |
| | | HQ India | |
| | 100K MW PCS | MPI Mussel | 8.5 |
| | | Polymers, | |
| | | Inc. aka the | |
| | | Applicant | |

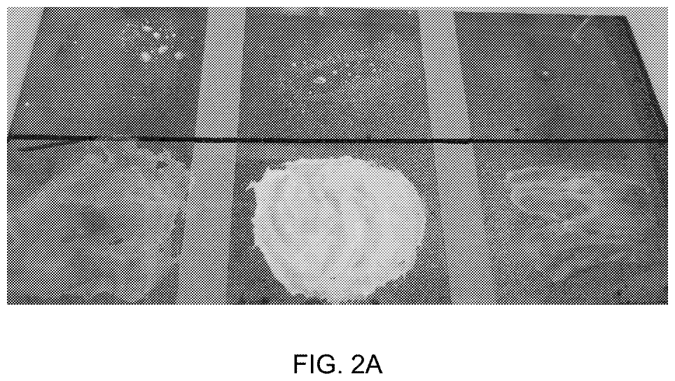

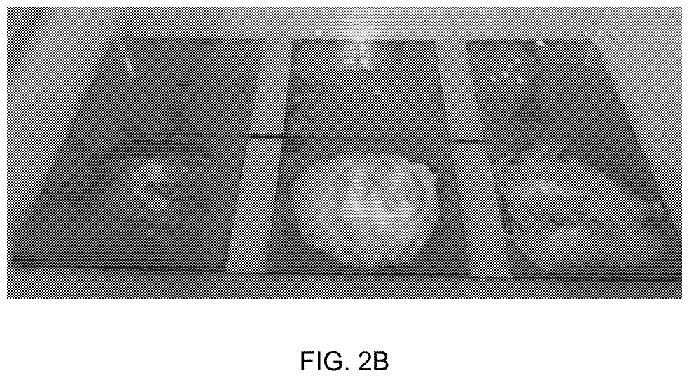

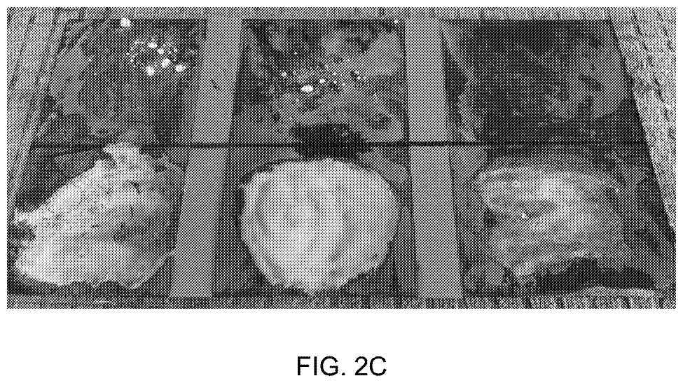

The formulas were mixed as described above and applied to DH36 steel submerged in tap water with a foam brush. In FIGS. 2A, 2B, and 2C, pictures of the samples are shown with the following order (top to bottom): initially after application, 72 h after application, and re-moved from the water and rinsed off after 72 h of submersion. In each picture from left to right (formula 1, 2, and 3) and top without PCS and bottom with PCS. As shown by these pictures, the PCS allows the epoxy to grab, bond and wet out the steel underwater, whereas without very little bonding and wet out.

Optimization of the formula in Table 2 above is includes the following variables: PCS MW; PCS catechol styrene to styrene molar ratio; Amine and Aspartic type(s) and MW; Isocyanate and epoxy type(s); Isocyanate to aspartic ratio; Epoxy to amine ratio; Type and concertation of fillers, pigments, corrosion inhibitors and surfactants on application and end-use performance; PCS concertation in the aspartic and epoxy; Type and concentration of reactive diluents and pot life extenders; PCS effect in polyols so applicable to urethane coatings.

### Example 3—the Effect of PCS Dissolved in an Amine on the Dry Adhesion of a 2-Part Epoxy Adhesive

0.15 g/ml 100K MW PCS was dissolved in Ancamine 2280. The Ancamine was mixed at a weight ratio of 1.7:1 epoxy:amine with EPON 828 epoxy. Another formula was made at the same ratio where the Ancamine did not contain PCS. The formulas are shown in Table 3 below. These formulas were applied to mechanically sanded and solvent wiped 1″×5″ 2024 aluminum coupons (3 replicates) for lap shear testing (ASTM D1002). The adhesive samples were heated to 60° C. for 1 h and allowed to cool before the lap shear testing.

TABLE 3
Epoxy Adhesive Formulas

| Adhesive | Ingredient | Supplier | wt. % |
|---|---|---|---|
| 1 | EPON 828 | Westlake Corp., | 63 |
| | | TX | |
| | Ancamine 2280 | Evonik, HQ | 31.8 |
| | | Germany | |
| | 100K MW PCS | MPI Mussel | 5.2 |
| | | Polymers, Inc. | |
| | | aka the | |
| | | Applicant | |
| 2 | EPON 828 | Westlake Corp., | 63 |
| | | TX | |
| | Ancamine 2280 | Evonik, HQ | 37 |
| | | Germany | |

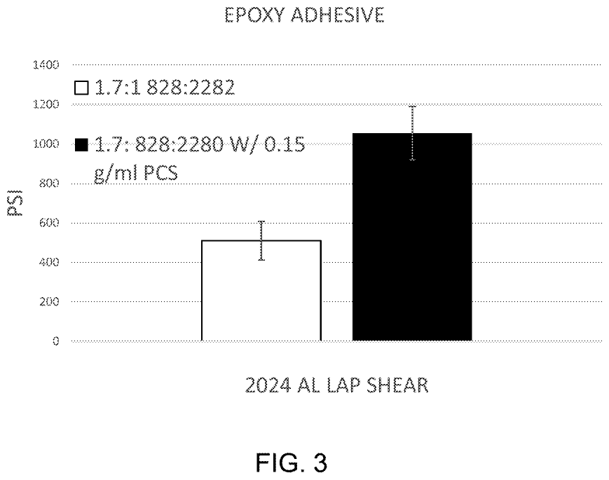

The lap shear data is shown in FIG. 3. Clearly the addition of PCS improved the adhesion of the 2-part epoxy adhesive to 2024 aluminum.

### Example 4—Pull Off Adhesion of Underwater Applied Aspartic Coatings

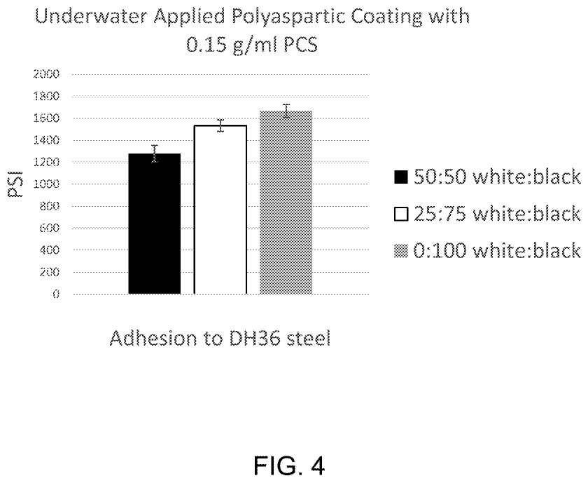

2-part polyaspartic coatings were made using Teraspartic 292 with 0.15 g/ml 100K PCS at three ratios of white to black pigment dispersions as shown in Table 4 below. These formulas were applied as in Example 1 to DH36 steel under water and allowed to cure under water for 24 h. They were removed and allowed to dry 24 h at room temperature. The dollies were applied as per ASTM D4541 and the samples were heated for 1 h at 60° C. The pull off adhesion showed a slight trend toward increasing adhesion with an increasing amount of black pigment. See FIG. 4. Also, a comparison of this data to a control coating without PCS cannot be done as this cannot be applied underwater as described in Example 1.

TABLE 4
Two-part polyaspartic formulas with various
ratios of white to black pigment dispersion

| | Formula 1 | Formula 2 | Formula 3 |
|---|---|---|---|
| Ingredient | wt. % | wt. % | wt. % |
| TERASPARTIC 292 | 34.57 | 34.57 | 34.57 |
| 100K PCS | 4.94 | 4.94 | 4.94 |
| TERACHEM WHITE | 8.64 | 4.32 | 0 |
| TERACHEM BLACK | 8.64 | 12.96 | 17.28 |
| Byk 306 | 5.76 | 5.76 | 5.76 |
| Halox 680 | 2.88 | 2.88 | 2.88 |
| TERACURE NX-19 | 34.57 | 34.57 | 34.57 |
| Total | 100.00 | 100.00 | 100.00 |

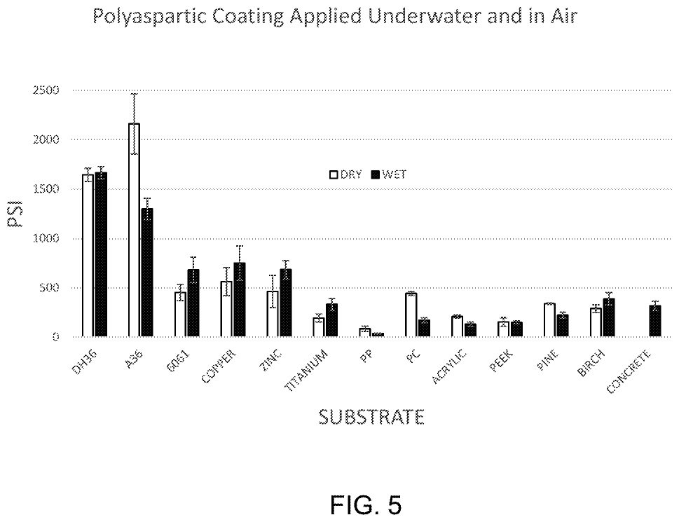

The same experiment was repeated applying the coating in Table 4 (Formula 1) to a variety of substrates as shown in FIG. 5. The coating was applied to each substrate with a roller both underwater and dry. The underwater coated samples were allowed to cure 24 h and then removed from the water and then dry out for 24 h at room temperature. The dollies were applied and allowed to cure for 72 at room temperature for both the dry and wet applied coatings. The data in the chart below shows the pull of values for each substrate both wet and dry applied. The following general observations were made:
Wet and dry value within the error bars were similar with the biggest exception being the A36 steel.
Metals both wet and dry had higher values than the plastics, woods, and concrete
Both alloys of steel (DH36 and A36) had the highest values and were greater than the other metals tested.

### Example 5:2—Part Polyurea Adhesive Formulations

Formulas 1-4 shown in the table 5 below were mixed at room temperature. The 100K (MW) PCS was dissolved in the amines (P-1000 and P2000) at 0.2 g per ml of amine. The ISO to NH and OH ratio was 1:1 on all formulas where the PCS was considered to have two reactive OH equivalents. The open or working time is the amount of time the formulation has a low enough viscosity to be applied. Both the isocyanate (TMXDI) and the amines (P-1000 and P-2000) are known to be “slow” reacting components for polyurea's. The open time of these formulations was over 24 h which is infinite to other polyurea's that react in less than one minute.

TABLE 5
Polyurea formulations

| Formula | Ingredient | Supplier | Wt. % |
|---|---|---|---|
| 1 | TMXDI | Allnex, CT | 15.4 |
| | P-1000 | GANTRADE, NJ | 84.6 |
| 2 | TMXDI | Allnex, CT | 9.5 |
| | P-2000 | GANTRADE, NJ | 90.5 |
| 3 | TMXDI | Allnex, CT | 23.1 |
| | P-1000 | GANTRADE, NJ | 76.9 |
| | 100K PCS | MPI Mussel | 14.4 |
| | | Polymers, Inc. aka | |
| | | the Applicant | |
| 4 | TMXDI | Allnex, CT | 18.4 |
| | P-2000 | GANTRADE, NJ | 81.6 |
| | 100K PCS | MPI Mussel | 16.3 |
| | | Polymers, Inc. aka | |
| | | the Applicant | |

Each formula was applied underwater to make lap shear and peel adhesive joints. Wetting and adhesion of the PCS containing formulas was much better visually than the without PCS formulas. Lap shear joints consisted of two mild steel 1′×5′ with a 1″ overlap. Peel joints were constructed by glueing a 1″×12″ Versathane 1000 rubber strip to A36 mild steel with an 8″×1″ bond area. Samples were allowed to age for 4 days at room temperature submerged in seawater. Samples were pulled by a tensile tester in accordance with ASTM D1002 (lap shear) and ASTM D6872 (peel). The adhesion data is given in Table 6 below. Clearly, the PCS containing formulas have better lap and peel adhesion.

TABLE 6
Lap shear and peel adhesion strength of polyurea adhesives

| Formula | PCS | Lap shear (psi) | Peel (lb./in) |
|---|---|---|---|
| 1 | No | 3 | 0 |
| 2 | No | 3 | 0 |
| 3 | Yes | 346 | 9 |
| 4 | Yes | 408 | 12 |

What is claimed:

1. A two-part curable composition comprising:
a. a first part comprising:
a nucleophilic amine-containing compound; and
a poly(catechol-styrene) (PCS) polymer;
and
b. a second part comprising:
an electrophilic compound that is capable of reacting with the nucleophilic amine-containing compound of the first part.

2. The two-part curable composition of claim 1, wherein the nucleophilic amine-containing compound is a polyamine or a secondary amine.

3. The two-part curable composition of claim 2, wherein the nucleophilic amine-containing compound is a polyamine.

4. The two-part curable composition of claim 2, wherein the nucleophilic amine-containing compound is a secondary amine.

5. The two-part curable composition of claim 4, wherein the secondary amine is an aspartic.

6. The two-part curable composition of any one of claims 1-5, wherein the electrophilic compound that is capable of reacting with the nucleophilic amine-containing compound comprises an isocyanate or an epoxy resin.

7. The two-part curable composition of claim 6, wherein the electrophilic compound that is capable of reacting with the nucleophilic amine-containing compound comprises an isocyanate.

8. The two-part curable composition of claim 6, wherein the electrophilic compound that is capable of reacting with the nucleophilic amine-containing compound comprises an epoxy resin.

9. The two-part curable composition of claim 1, wherein the nucleophilic amine-containing compound is an aspartic, and the electrophilic compound that is capable of reacting with the nucleophilic amine-containing compound is an isocyanate.

10. The two-part curable composition of claim 1, wherein the nucleophilic amine-containing compound is a polyamine, and the electrophilic compound that is capable of reacting with the nucleophilic amine-containing compound is an epoxy resin.

11. The two-part curable composition of any one of claims 1-10, wherein the first part comprises from about 1% to about 15% PCS by weight of the two-part curable composition.

12. The two-part curable composition of claim 11, wherein the first part comprises from about 4% to about 10% PCS by weight of the two-part curable composition.

13. The two-part curable composition of any one of the preceding claims, wherein the PCS has a molecular weight in the range of from about 5,000 Da to 400,000 Da as measured by gel permeation chromatography (GPC).

14. The two-part curable composition claim 13, wherein the PCS has a molecular weight of about 100 kDa.

15. The two-part curable composition of any one of the preceding claims, wherein the PCS has a polydispersity index (PDI) of about 1 to about 4 as measured by GPC.

16. The two-part curable composition of claim 15, wherein the PCS has a polydispersity index (PDI) of about 2 to about 3 as measured by GPC.

17. The two-part curable composition of any one of the preceding claims, wherein the first part further comprises a pigment, a surfactant, a corrosion inhibitor, a filler, or a combination thereof.

18. The two-part curable composition of claim 17, wherein the pigment comprises a titanium white pigment.

19. The two-part curable composition of claim 17 or claim 18, wherein the pigment comprises TERACHEM® White.

20. The two-part curable composition of claim 17, wherein the pigment comprises tinting black.

21. The two-part curable composition of claim 17 or claim 20, wherein the pigment comprises TERACHEM® Black.

22. The two-part curable composition of any one of claims 14-21, wherein the surfactant comprises a silicone-based surfactant.

23. The two-part curable composition of claim 22, wherein the silicone-based surfactant comprises BYK®-306.

24. The two-part curable composition of any one of claims 14-23, wherein the corrosion inhibitor comprises an organic corrosion inhibitor.

25. The two-part curable composition of claim 24, wherein the organic corrosion inhibitor comprises HALOX® 680.

26. The two-part curable composition of any one of claim 6-25, wherein the isocyanate comprises a low-viscosity aliphatic polyisocyanate.

27. The two-part curable composition of any one of claim 6-26, wherein the isocyanate comprises TERACURE® NX-19.

28. The two-part curable composition of any one of the preceding claims, wherein the first part and the second part are combined in a weight ratio of about 0.1:1 to about 8:1 (second part:first part).

29. The two-part curable composition of any one of the preceding claims, wherein the first part and the second part are combined in a weight ratio of about 1.2:1 (second part:first part).

30. The two-part curable composition of any one of the preceding claims, wherein the first part and the second part are combined in a weight ratio of about 7:1 (second part:first part).

31. A process of preparing the two-part curable composition of any one of the preceding claims, comprising preparing the first part by mixing the nucleophilic amine-containing compound and the poly(catechol-styrene) (PCS) polymer, and optionally any additives; preparing the second part by optionally mixing any additives with the electrophilic compound that is capable of reacting with the nucleophilic amine-containing compound of the first part; and then mixing the first part with the second part.

32. A substrate comprising the two-part curable composition of any one of claims 1-30.

33. A cured or partially-cured composition formed by curing of the two-part curable composition of any one of claims 1-30.

34. A substrate comprising the composition of claim 33.

35. A substrate comprising a composition wherein the composition is prepared by the process of claim 31.

36. The two part composition of claim 32 applied as a coating, an adhesive, a sealant, a filler, or a combination thereof to the substrate.

37. The cured or partially-cured composition of claim 33 applied as a coating, an adhesive, a sealant, a filler, or a combination thereof to the substrate.
